(19) United States
(12) Patent Application Publication
(10) Pub. No.: US 2007/0217728 A1
(43) Pub. Date: Sep. 20, 2007

(54) Hub Unit, Rolling Bearing Assembly and Manufacture Method Thereof, as Well as Assembling Apparatus for Rolling Bearing Assebly and Assebly Method Thereof

(76) Inventors: Shinichirou Kashiwagi, Yao-shi (JP); Shinnosuke Takasaki, Kashiwara-shi (JP); Yuichi Nakagawa, Minamikawachi-gun (JP); Tsuyoshi Kamikawa, Nara-shi (JP); Masaru Deguchi, Kashiwara-shi (JP); Masahiro Inoue, Nara-shi (JP)

Correspondence Address: BIRCH STEWART KOLASCH & BIRCH, PO BOX 747, FALLS CHURCH, VA, 22040-0747, US

(21) Appl. No.: 11/662,728

(22) PCT Filed: Sep. 28, 2005
(86) PCT No.: PCT/JP05/17885

§ 371 Date: Mar. 14, 2007

(30) Foreign Application Priority Data
Sep. 30, 2004 (JP) 2004-286949
Sep. 30, 2004 (JP) 2004-285075
Nov. 25, 2004 (JP) 2004-340856

(51) Int. Cl. F16C 35/00; F16C 13/00

(52) U.S. Cl. 384/544; 384/589

(57) ABSTRACT

A rolling bearing adapted to prevent crack formation in a caulking portion is provided. A rolling bearing assembly includes: a hub shaft having the caulking portion at an axial end thereof, the caulking portion bendably deformed in a radially outward direction; the rolling bearing mounted on an outside surface of the hub shaft; and an annular member spline-engaged with the hub shaft and caulk-fixed to place by the caulking portion. An inner-side axial end of a second male spline formed on the hub shaft is shifted from an inner-side end of the hub shaft toward an outer side far enough to ensure that the second male spline is not susceptible to the plastic deformation of the caulked caulking portion.

Hub unit, rolling bearing assembly and manufacture method thereof, as well as assembling apparatus for rolling bearing assembly and assembly method thereof.

### TECHNICAL FIELD

The present invention relates to a hub unit for use in an automotive freewheel hub mechanism, for example, a rolling bearing assembly for use in the hub unit mounted to an automotive vehicle or the like, and a manufacture method thereof. The invention also relates to an assembling apparatus for bearing assembly which assembles an annular member by caulking an end of an inner shaft and an assembling method thereof.

### BACKGROUND ART

A full-time 4WD vehicle and a part-time 4WD vehicle are known as four-wheel drive vehicles. The part-time 4WD vehicle is a vehicle adapted for shifting between a 2WD drive mode and a 4WD drive mode. This four-wheel drive vehicle is designed to bring driven wheels into a free state by disconnecting, for example, the driven wheels from an axle shaft of a driving system, thereby inhibiting the transmission of the rotation of the axle shaft to the driven wheels. This vehicle includes a mechanism (freewheel hub mechanism) which brings the driven wheels into a locked state by connecting the driven wheels to the axle shaft of the driving system, thereby permitting a driving force of an engine to be transmitted to the driven wheels. Such a part-time 4WD vehicle has advantages of improving fuel economy and reducing noises.

The freewheel hub mechanism is disclosed in Published Japanese Translation of PCT International Patent Publication No. 2003-507683, for example. The freewheel hub mechanism employs a hub unit including: a hub shaft (hereinafter, also referred to as “hub wheel”) coaxially mounted on an axle shaft; a rolling bearing disposed on an outside surface of the hub shaft; and a coupler ring (hereinafter, also referred to as “annular member”) axially juxtaposed to the rolling bearing. The annular member of the hub unit is formed with an outer-peripheral spline portion on an outside surface thereof. The outer-peripheral spline portion may be spline-engaged (meshed) with a spline portion of a gear ring. The driven wheels may be shifted between the connection with the axle shaft and the disconnection from the axle shaft by axially sliding the gear ring. Specifically, the coupler ring is formed with splines on its outside and inside surfaces. The inner-peripheral spline is spline-engageable with the outside surface of the hub shaft, whereas the outer-peripheral spline is spline-engageable with the gear ring of a shift linkage device. When the coupler ring on the hub shaft is in spline-engagement with the gear ring of the shift linkage device, the driving torque from the shift linkage device is transmitted to the hub shaft via the coupler ring. Thus permits the hub unit to function in a drive wheel mode. When the coupler ring is brought out of the spline-engagement, the hub unit is capable of functioning in a driven wheel mode.

A general vehicular hub unit includes a rolling bearing assembly, which includes the rolling bearing. The rolling bearing supports the hub shaft as mounted on the outside surface of the hub shaft as a shaft body to which a road wheel, a disk rotor of a disk brake apparatus and the like are mounted.

Such a rolling bearing assembly includes one which is arranged such that a driving shaft is inserted through an inner periphery of the hub shaft for driving the hub shaft into rotation. The driving shaft has its tip thread-engaged with a stop nut which axially presses the rolling bearing mounted on the hub shaft. The stop nut prevents the rolling bearing from disengaging from the hub shaft and applies a preload to the rolling bearing. However, the use of the driving shaft and the stop nut leads to a cumbersome manufacture operation and to the weight increase of the hub unit.

In this connection, a hub unit disclosed in Published Japanese Translation of PCT International Patent Publication No. 2003-507683 adopts a method wherein a coupler-ring side end (the opposite end from a flange) of a hub shaft including the flange is radially outwardly bent for pressing the rolling bearing and the couple ring (the process is called “shaft-end caulking”) This coupler ring is assembled to the hub shaft as follows. First, an inner ring member of the roller bearing is fitted on an outside surface of a shaft portion of the hub shaft. Subsequently, the coupler ring is fitted on an outside surface of an end of the hub shaft, and a part of the hub shaft end is caulked in a manner to be expanded radially outwardly. Thus, the inner ring member and the coupler ring are fixed to the hub shaft in an anti-fall fashion.

Such a shaft-end caulking permits the rolling bearing and the coupler ring to be fixed to the hub shaft. Furthermore, the shaft-end caulking negates the need for an independent fastening member, thus contributing to the reduction of the number of components.

On the other hand, Japanese Unexamined Patent Publication No. 2001-163003 discloses a hub shaft mounted with the rolling bearing and formed with a caulking cylinder portion at an axial end thereof. An annular member for coupling an axle shaft with the hub shaft is spline-engaged with the outside surface of the hub shaft. The annular member is caulk-fixed to place by bendably deforming the caulking cylinder portion in a radially outward direction. Thus is provided a rolling bearing assembly obviating the aforesaid driving shaft inserted through the inner periphery of the hub shaft and the aforesaid stop nut.

### DISCLOSURE OF THE INVENTION

However, there is a problem that the end of the hub shaft is prone to suffer the formation of cracks (called “caulking cracks”) at its root portion because the end of the hub shaft is radially outwardly bent in the shaft-end caulking process. The invention disclosed in Published Japanese Translation of PCT International Patent Publication No. 2003-507683 overcomes this problem by interposing an independent ring member for increasing a bend radius. However, the use of the independent ring member leads to an increased number of components, thus resulting in a lowered production efficiency and inability to reduce costs. The hub unit assembled by the shaft-end caulking has a specific problem that in a case where this hub unit is applied to the freewheel hub mechanism and is actually operated, for example, the hub shaft is prone to suffer the crack formation at a root portion of the bent end because stress is concentrated on the root portion.

The above invention disclosed in Japanese Unexamined Patent Publication No. 2001-163003 is described with reference to FIG. 10. When a caulking cylinder portion 152 at an axial end of a hub shaft 151 is caulked to an annular member 153, a caulking portion 155 sustains local deformation. This produces cracks 156 at the caulking portion 155 pressing the annular member 153. Hence, the caulking portion 155 is decreased in strength so that the bearing disengages from the hub shaft 151.

In the case where the annular member is fixed to the hub shaft by caulking, the annular member or the coupler ring is expanded by the caulking process. If the annular member or the like is excessively expanded, the annular member or the like suffers the crack formation. The spline formed on the outside surface of the annular member or the like must be so formed as to provide outside dimensions of the annular member or the like within predetermined accuracies in order to accomplish the spline-engagement with the gear ring of the shift linkage device and a housing of a joint of the axle shaft.

In view of the foregoing, it is a first object of the invention is to provide a hub unit and a rolling bearing assembly which are adapted for effective prevention of the formation of caulking cracks during the shaft-end caulking or the crack formation during use. A second object of the invention is to provide an assembling apparatus for rolling bearing assembly and an assembling method thereof which are adapted to reduce the expansion of the annular member or such assembled by the caulking process and to restrict the quantity of expansion of the annular member or such associated with the caulking process to a constant value despite the variations of the outside diameter of the annular member or such.

According to the invention for achieving the first object, a hub unit comprises: a hub shaft including: a sleeve formed about an outside surface of a rotary shaft in a coaxial relation therewith; a flange formed at a first axial end of the sleeve and extended radially outwardly therefrom; and a bent portion (caulking portion) formed at a second axial end of the sleeve as bent radially outwardly; and a spline portion formed on an outside surface of the sleeve at place in the vicinity of the bent portion; a rolling bearing including an inner ring, an outer ring and rolling elements interposed between the inner ring and the outer ring, and fitted on the sleeve of the hub shaft; and a coupler ring including an inner-peripheral spline portion formed on an inside surface thereof and an outer-peripheral spline portion formed on an outside surface thereof, and meshed with the spline portion of the hub shaft at the inner-peripheral spline portion, the bent portion of the hub shaft pressing the rolling bearing via the coupler ring, and is characterized in that a second-end chamfer portion is formed by curvedly chamfering circumferential edges of second axial ends of spline ridges of the inner-peripheral spline portion of the coupler ring, and the whole body of the second-end chamfer portion is located axially outwardly of the spline portion of the hub shaft.

According to the above constitution, the whole body of the second-end chamfer portion is located axially outwardly of the spline portion of the hub shaft, so that a bend radius of the bent portion of the hub shaft may be increased. Therefore, the formation of cracks (caulking cracks) at a root portion of the bent portion may be effectively prevented when the bent portion is formed by bending the second axial end of the hub shaft (during the shaft-end caulking). Furthermore, the bent portion may be reduced in stress concentration during use by virtue of the great bend radius thereof, so that the crack formation at the root portion of the bent portion is effectively avoided. What is more, the above constitution does not require the use of the independent ring member in contrast to the teaching of Published Japanese Translation of PCT International Patent Publication No. 2003-507683 mentioned above. Hence, the invention offers the advantages of high production efficiency and easy cost reduction.

It is preferred in the above hub unit that a first-end chamfer portion is formed by curvedly chamfering circumferential edges of first axial ends of the spline ridges of the inner-peripheral spline portion of the coupler ring, and the whole body of the first-end chamfer portion is located in spline grooves of the spline portion of the hub shaft. In this case, a meshing engagement region between the inner-peripheral spline portion of the coupler ring and the spline portion of the hub shaft may be increased in axial contact length and hence, torsion strength may be increased further.

It is also preferred in the above hub unit that a plurality of recesses are formed in a side surface of a second axial end of the coupler ring and the bent portion is wedged into these recesses. In this case, the coupler ring and the rolling bearing may be fixed to place more firmly and hence, the hub unit may be even further increased in the torsion strength.

According to the invention for achieving the first object, a rolling bearing assembly comprises: a hub shaft having a radially outwardly caulked caulking portion at an inner-side end thereof; a rolling bearing mounted on an outside surface of the hub shaft; and an annular member spline-engaged with the outside surface of the hub shaft and caulk-fixed to place by the caulking portion, and is characterized in that an inner-side axial end of an outer-peripheral spline formed on the hub shaft is shifted from the inner-side end of the hub shaft to an outer side far enough to ensure that the outer-peripheral spline is not susceptible to the plastic deformation of the caulking portion thus caulked.

In this case, the inner-side axial end of the outer-peripheral spline of the hub shaft is shifted from the inner-side end of the hub shaft to the outer side so that the outer-peripheral spline may not be susceptible to the plastic deformation of the caulking portion. Accordingly, the caulking portion is formed without causing the plastic deformation of the outer-peripheral spline.

Thus, the caulking portion is formed by deforming only a portion free from the outer-peripheral spline. Hence, the caulking portion does not undergo a rapid deformation (local deformation) so as to be prevented from suffering the crack formation. If the caulking process causes the plastic deformation of the outer-peripheral spline, a clearance may be formed between the annular member and the caulking portion.

It is preferred in the above rolling bearing assembly that the caulking portion is formed by bendably deforming a caulking cylinder portion formed with a dent portion on an outside surface thereof, the dent portion conforming to an inside corner portion of the annular member.

In this case, the dent portion formed at the caulking cylinder portion conforms to the inside corner portion of the annular member, thus facilitating the deformation of the caulking cylinder portion. This leads to an increased effect to prevent the crack formation at the caulking portion.

The above rolling bearing assembly may provide the following advantage if an inner-peripheral spline formed on the annular member is extended only in a range between an outer-side end of the annular member and an axial intermediate point thereof. The inside corner portion of the annular member caulk-fixed to place is free from a circumferential corrugation, thus defining a smooth surface. Therefore, the caulking portion is deformed as evenly pressed against the inside corner portion of the annular member at its side opposite the inside corner portion. This leads to an even further increased effect to prevent the crack formation at the caulking portion.

A method of manufacturing a rolling bearing assembly according to the invention comprises the steps of mounting a rolling bearing on an outside surface of a hub shaft including a caulking cylinder portion at an inner-side end thereof; bringing an annular member into spline-engagement with an outer-peripheral spline formed on the hub shaft by sliding the annular member from an inner side toward an outer side; and caulk-fixing the annular member to place with a caulking portion formed by radially outwardly bending the caulking cylinder portion, and is characterized in that the annular member is spline-engaged with the outer-peripheral spline, an axial end of which is shifted toward the outer side far enough to ensure that the outer-peripheral spline is not susceptible to the plastic deformation of the caulking portion.

According to the manufacture method, the axial end of the outer-peripheral spline of the hub shaft is shifted to the outer side so that the outer-peripheral spline is not affected by the plastic deformation of the caulking portion. This permits the caulking portion to be caulked without causing the plastic deformation of the outer-peripheral spline. That is, the caulking portion may be formed by deforming only a portion free from the outer-peripheral spline. Hence, the caulking portion does not undergo a rapid deformation (local deformation) so as to be prevented from suffering the crack formation.

According to the invention for achieving the second object, an assembling apparatus for rolling bearing assembly which is assembled by fitting an annular member on an outside surface of an end of an inner shaft (hub shaft) having an inner ring member fitted thereon, and radially outwardly caulking an outer-peripheral end of the inner shaft thereby fixing the annular member and the inner ring member to the inner shaft in an anti-fall fashion, the apparatus comprises a constraining ring which is brought into fitting contact against an outside surface of the annular member during the caulking process, thereby preventing the diametral expansion of the annular member.

According to the assembling apparatus of this constitution, the annular member assembled by the caulking process may be prevented from being expanded so that a high-accuracy assembling operation may be accomplished. Furthermore, the annular member may be prevented from suffering deformation or cracks resulting from an excessive expansion thereof.

It is also preferred that the constraining ring comprises a plurality of separate constraining ring segments arranged in a circumferential direction. This constitution is adapted to restrict the quantity of expansion of the annular member associated with the caulking process to a constant value despite the variations of the outside diameter of the annular member. Specifically, the expansion quantity of the annular member is related with a gap defined between an inside surface of the constraining ring and the outside surface of the annular member. Hence, the greater the gap, the greater is the expansion quantity. It is a general practice to provide greater tolerances of the outside diameter of the annular member (coupler) than tolerances of the inner ring member of the bearing. On the other hand, the inside surface of the constraining ring normally has a fixed inside diameter. Therefore, the gap between the constraining ring and the annular member varies from product to product. However, the constraining ring is circumferentially divided into plural segments and hence, is adapted to vary the inside diameter thereof. That is, the constraining ring is capable of accommodating the tolerances of the outside diameter of the annular member. Accordingly, the apparatus permits the assembling operation to be carried on without exchanging the constraining rings, achieving an increased productivity. The apparatus may favorably be applied to mass production of the bearing assembly.

It is also preferred that the constraining ring segment is allowed to move radially without varying the angle of an inside abutment surface thereof relative to an axis of the inner shaft. According to the constitution, the inside abutment surface of the constraining ring segment may be constantly held in face contact against the outside surface of the annular member. Thus, the expansion of the annular member is prevented and besides, the annular member is assuredly prevented from being tilted. If the inside abutment surface of the constraining ring is tilted relative to the axis of the inner shaft (the angle of the inside abutment surface relative to the axis of the inner shaft is varied) when the constraining ring is decreased in the diameter to constrain the annular member, the constraining ring makes linear contact against the annular member so as to hold the annular member unstably. What is more, the annular member is tilted when subjected to a circumferentially biased force. However, the invention is adapted to obviate these drawbacks.

Even in a case where the annular member is formed with the spline on the outside surface thereof, it is preferred that the inside abutment surface of the constraining ring brought into contact against the outside surface of the annular member is defined by a smooth surface. The reason is that the spline has higher dimensional accuracies at a distal end side thereof than at a bottom thereof and hence, the deformation of the annular member may be corrected by bringing the inside abutment surface of the constraining ring into contact against the distal end side of the annular member. This also leads to an improved roundness of the annular member.

According to the invention for achieving the second object, a method of assembling a bearing assembly comprises the steps of fitting an annular member on an outside surface of an end of an inner shaft having an inner ring member fitted thereon, and radially outwardly caulking an outer-peripheral end of the inner shaft thereby fixing the annular member and the inner ring member to the inner shaft in an anti-fall fashion, and is characterized in that a constraining ring is brought into fitting contact against an outside surface of the annular member during the caulking process, thereby preventing the diametral expansion of the annular member. According to the assembling method of this constitution, the expansion of the annular member being assembled by the caulking process may be prevented so that the high-accuracy assembling operation may be accomplished. Furthermore, the annular member may be prevented from suffering deformation or cracks resulting from the excessive expansion thereof.

It is also preferred in this assembling method that the constraining ring comprises a plurality of separate constraining ring segments arranged in a circumferential direction and the individual constraining ring segments are moved in a diameter decreasing direction for making contact against the outside surface of the annular member. This constitution is adapted to restrict the quantity of expansion of the annular member associated with the caulking process to a constant value despite the variations of the outside diameter of the annular member. What is more, the method permits the assembling operation to be carried on without exchanging the constraining rings if the annular members are varied in the outside diameter. Hence, the method achieves an increased productivity and may be favorably applied to the mass production of the bearing assembly.

### BRIEF DESCRIPTION OF THE DRAWINGS

FIG. 1 is a sectional view showing a hub unit according to a first embodiment of the invention;

FIG. 2 is an enlarged sectional view showing a neighborhood of a coupler ring of the hub unit;

FIG. 3 is an enlarged sectional view for explaining a shaft-end caulking;

FIG. 4 is an enlarged sectional view showing a neighborhood of a coupler ring in a hub unit according to a second embodiment hereof;

FIG. 5 is a sectional view showing a rolling bearing assembly according to the first embodiment hereof;

FIG. 6 is a sectional view showing a state before a caulking portion of the rolling bearing assembly shown in FIG. 5 is caulked;

FIG. 7 is a sectional view showing a state after the caulking portion of the rolling bearing assembly shown in FIG. 5 is caulked;

FIG. 8 is a sectional view showing a state before a caulking portion of a rolling bearing assembly according to the second embodiment hereof is caulked;

FIG. 9 is a sectional view showing a state before a caulking portion of a rolling bearing assembly according to a third embodiment hereof is caulked;

FIG. 10 is a sectional view showing a state after a caulking portion of a prior-art rolling bearing assembly is caulked;

FIG. 11 is a sectional view showing an essential part of an assembling apparatus according to an embodiment of the invention;

FIG. 12 is a sectional view showing the assembling apparatus of FIG. 11;

FIG. 13 is a sectional view showing an assembling apparatus according to another embodiment hereof;

FIG. 14 is a sectional view showing a diametral-expansion inhibiting jig including a constraining ring;

FIG. 15 is a sectioned plan view showing the diametral-expansion inhibiting jig including the constraining ring; and

FIG. 16 is a graph showing the expansion quantity of an annular member in a case where the constraining ring is used.

### BEST MODES FOR CARRYING OUT THE INVENTION

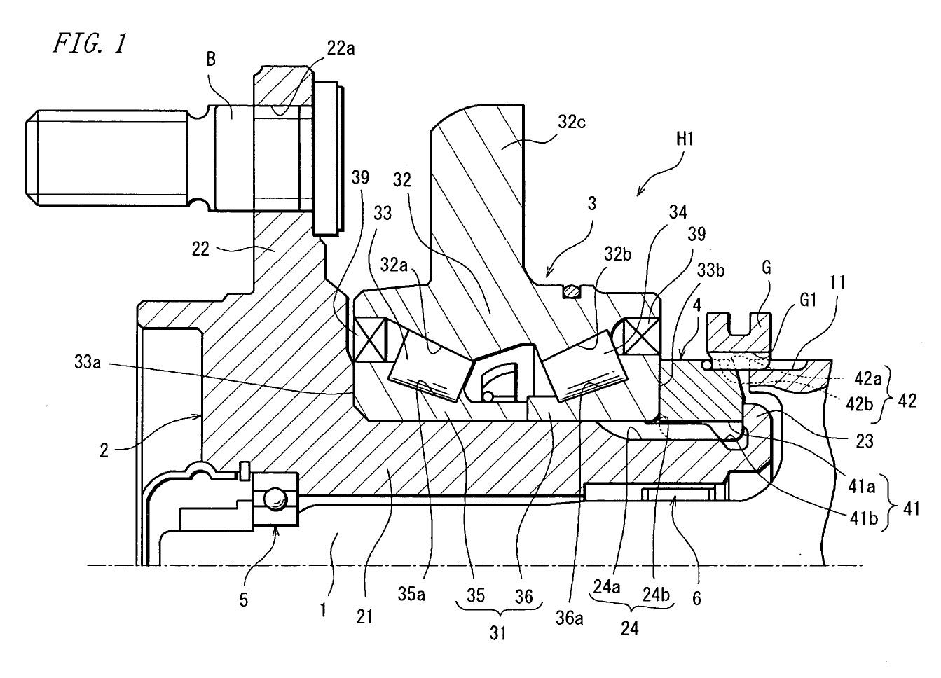

Preferred embodiments of the invention will hereinbelow be described with reference to the accompanying drawings. FIG. 1 is a sectional view showing a hub unit according to a first embodiment of the invention. A hub unit H1 according to the invention is used in, for example, a freewheel hub mechanism of a part-time 4WD vehicle. The freewheel hub mechanism includes: a hub shaft 2 coaxially mounted on an axle shaft 1 of a driving system; a double-row tapered roller bearing 3 as a rolling bearing fitted on an axially intermediate portion of the hub shaft 2; and a coupler ring 4 (annular member) axially juxtaposed to this double-row tapered roller bearing 3. The hub unit H1 is rotatably carried by a deep groove ball bearing 5 and a needle roller bearing 6 in a coaxial relation with the axle shaft 1 (carried in a manner to be circumferentially rotatable relative to the axle shaft 1), the deep groove ball bearing 5 and the needle roller bearing 6 interposed between the axle shaft 1 and the hub shaft 2. A gear ring G is slidably movable in an axial direction.

The hub shaft 2 includes: a sleeve 21 formed in a coaxial relation with the axle shaft 1; a flange 22 formed at a first end (road-wheel side) of the sleeve 21 and extended radially outwardly therefrom; and a bent portion (also referred to as a caulking portion) 23 formed at a second end (vehicular center side) of the sleeve 21 as bent radially outwardly. The sleeve 21 is also formed with a spline portion 24 on an outside surface thereof at place in the vicinity of the bent portion 23, the spline portion including plural spline grooves 24a and spline ridges 24b formed in alternating relation. The spline portion 24 is so formed as to mesh with an inner-peripheral spline portion 41 formed on an inside surface of the coupler ring 4. The flange 22 is formed with a through-hole (fastening hole) 22a. A fastening member B such as a bolt is inserted through this through-hole (fastening hole) 22a. Thus, the hub shaft may be fastened to a wheel (not shown) of the road wheel as a rotary member.

The double-row tapered roller bearing 3 includes: an inner ring 31, an outer ring 32, and tapered rollers 33, 34 as rolling elements interposed between the inner and outer rings 31, 32 as axially arranged in two rows.

More specifically, the inner ring 31 is divided into a first inner ring member 35 possessing a first raceway 35a, and a second inner ring member 36 possessing a second raceway 36a. The first inner ring member 35 and the second inner ring member 36 adjoin each other. An end face 33a of the first inner ring member 35 is pressed against a root portion of the flange 22 of the hub shaft 2. On the other hand, an end face 33b of the second inner ring member 36 is pressed against an end face of the coupler ring 4. Thus, the coupler ring 4 and the inner ring 31 (the first inner ring member 35 and the second inner ring member 36) constituting the double-row tapered roller bearing 3 are fixed in space defined between the root portion of the flange 22 of the hub shaft 2 and the bent portion 23 of the hub shaft 2. Furthermore, a constitution is made such that these components are inhibited from rotating relative to the hub shaft 2.

On the other hand, the outer ring 32 includes a first raceway 32a and a second raceway 32b as well as a flange 32c extended radially outwardly. The flange 32c is fixed to place as mounted to a steering knuckle (suspension system) and the like of a vehicle body. Indicated as 39 is a seal member. While the embodiment employs the double-row tapered roller bearing 3 having the tapered rollers axially arranged in two rows, it goes without saying that other types of rolling bearings and ball bearings are also usable.

The coupler ring 4 is generally formed in an annular shape and is axially juxtaposed to the double-row tapered roller bearing 3 in a manner to abut against the second end face of the roller bearing (the end face 33b of the second inner ring member 36). The coupler ring 4 is formed with an outer-peripheral spline portion 42 on an outside surface thereof, the outer-peripheral spline portion including plural spline grooves 42a and plural spline ridges 42b formed in an alternating relation. The outer-peripheral spline portion 42 is so formed as to mesh with a spline G1 of the gear ring G.

On the other hand, the inside surface of the coupler ring 4 is formed with the inner-peripheral spline portion 41 including plural spline grooves 41a and plural spline ridges 41b formed in an alternating relation. As described above, the inner-peripheral spline portion 41 is so formed as to mesh with the spline portion 24 of the hub shaft 2.

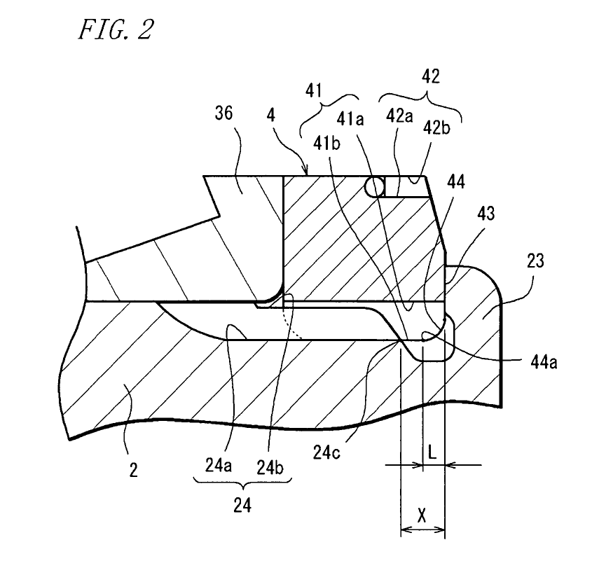

Also referring to FIG. 2, in the inner-peripheral spline portion 41 of the coupler ring 4, circumferential edges of the spline ridges 41b at the second axial ends thereof are curvedly chamfered to define a second-end chamfer portion 44. The whole body of the second-end chamfer portion 44 is so formed as to be located axially outwardly of the spline portion 24 of the hub shaft 2. Specifically, it is provided that L denotes a distance between a side surface 43 of the second-axial-end of the coupler ring 4 and a first end 44a of the second-end chamfer portion 44. It is provided that X denotes a distance between the second-end side surface 43 of the coupler ring 4 and an end point 24c of the spline groove 24a of the spline portion 24 of the hub shaft 2. In this case, the chamfer portion 44 is formed in a manner that the distance L is smaller than the distance X. This provides a great bend radius of the bent portion defined by the second axial end of the hub shaft 2 bendingly pressed against to place. Thus, the bent portion 23 may be effectively prevented from sustaining cracks (caulking cracks) at its root portion.

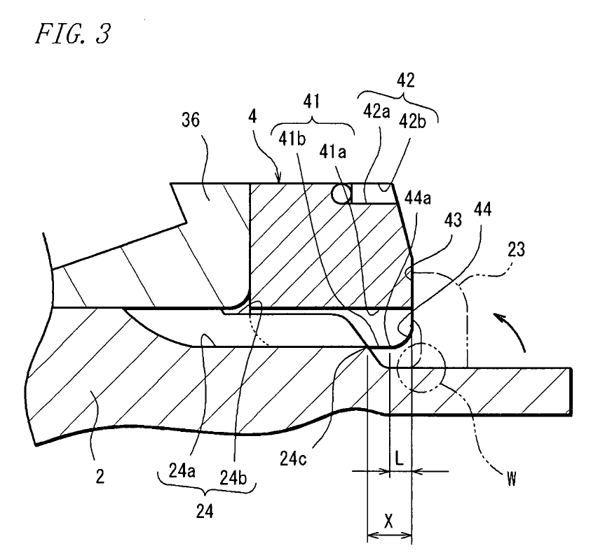

As will be described in greater detail with reference to FIG. 3, the double-row tapered roller bearing 3 and the coupler ring 4 in this order as seen from the flange 22 are mounted on the hub shaft 2 prior to the formation of the bent portion 23. Subsequently, the second end of the hub shaft 2 is radially outwardly bent to form the bent portion 23. Thus is accomplished the shaft-end caulking. If the whole body of the second-end chamfer portion 44 of the coupler ring 4 is located axially outwardly of the spline portion 24 of the hub shaft 2, the second end (bent portion) of the hub shaft 2 is increased in the bend radius. Accordingly, the bent portion 23 undergoing the shaft-end caulking is effectively prevented from sustaining cracks at its root portion W. The second end of the hub shaft 2 may be bent to such a degree that the second end pressed against the coupler ring 4 applies a proper pre-load to the double-row tapered roller bearing via the coupler ring 4.

The hub unit H1 of the aforementioned constitution may be used in, for example, a freewheel hub mechanism of a part-time 4WD vehicle. The hub unit is adapted for on/off transmission of a driving force (torque) of the axle shaft 1 as follows. First, referring to FIG. 1, when the axially slidably movable gear ring G is in a lock state as having its the spline G1 meshed with the outer-peripheral spline portion 42 of the coupler ring 4, the driving force of the axle shaft 1 is transmitted to the hub shaft 2 via the gear ring G and the coupler ring 4. The driving force is further transmitted to the wheel (not shown) of the road wheel as the rotary member fastened to the hub shaft by means of the fastening member B inserted through the through-hole (fastening hole) 22a in the flange 22 of the hub shaft 2. When, on the other hand, the gear ring G is slidably moved to the second axial end (the vehicular center side) so as to be in a free state (not shown) as placing the spline G1 thereof out of the meshing engagement with the outer-peripheral spline portion 42 of the coupler ring 4, the driving force of the axle shaft 1 is not transmitted to the coupler ring 4 so that the driving force is not also transmitted to the wheel (not shown) of the road wheel as the rotary member. In this manner, the on/off transmission of the driving force of the axle shaft 1 may be made by way of the sliding movement of the gear ring G. The sliding movement of the gear ring G may be provided by known means for slidably moving the gear ring.

In the hub unit H1 having the above constitution according to the embodiment, the whole body of the second-end chamfer portion 44 formed at the second-end circumferential edges of the spline ridges 41b of the inner-peripheral spline portion 41 of the coupler ring 4 is located axially outwardly of the spline portion 24 of the hub shaft 2. Therefore, the bent portion 23 of the hub shaft has a great bend radius. This is effective to prevent the bent portion 23 from sustaining cracks (caulking cracks) at its root portion W when the second axial end of the hub shaft 2 is bent to form the bent portion 23 (during the shaft-end caulking). Furthermore, the hub unit is adapted to reduce stress concentration on the root portion W of the bent portion 23 in a case where the hub unit is actually used in the freewheel hub mechanism. This also leads to an effective prevention of the crack formation at the root portion W of the bent portion. What is more, the hub unit negates the need for the use of the independent ring-like member in contrast to the teaching of the above Published Japanese Translation of PCT International Patent Publication No. 2003-507683. Because of the decreased number of components, the hub unit offers advantages of good production efficiency and easy cost reduction.

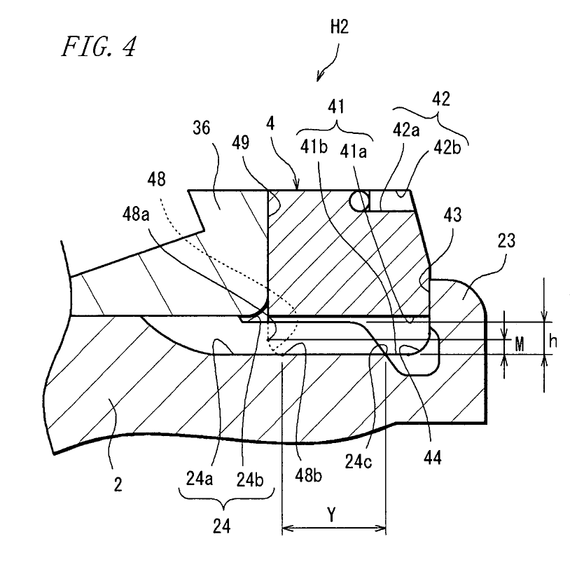

FIG. 4 is a sectional view showing a neighborhood of a coupler ring of a hub unit according to a second embodiment of the invention. A hub unit H2 according to the embodiment differs from that of the first embodiment in that a first-end chamfer portion 48 is formed at circumferential edges of first axial ends of the spline ridges 41b of the inner-peripheral spline portion 41 of the coupler ring 4, and the whole body of the chamfer portion 48 is located in the spline grooves 24a of the spline portion 24 of the hub shaft 2. Specifically, the first-end chamfer portion 48 is formed such that a distance M between a first end thereof 48a (a bottom-side of the spline groove 41a of the inner-peripheral spline portion 41 of the coupler ring 4) and a bottom of the spline groove 24a of the hub shaft 2 is smaller than a height h of the spline portion 24 of the hub shaft 2. If the whole body of the second-end chamfer portion 44 of the coupler ring 4 is located axially outwardly of the spline portion 24 of the hub shaft 2 for the purpose of effectively preventing the crack formation during the caulking or the use of the hub unit as suggested by the first embodiment, there is a tendency that a meshing engagement region (meshing engagement area) between the inner-peripheral spline portion 41 of the coupler ring 4 and the spline portion 24 of the hub shaft 2 is decreased in axial contact length Y so that the hub unit suffers an insufficient torsion strength. Specifically, a hub unit having common dimensions tends to be lowered in the torsion strength if the axial contact length Y of the meshing engagement region is 7.0 mm or less. According to the embodiment, in contrast, the axial contact length Y of the meshing engagement region may be increased by reducing the size of the first-end chamfer portion 48 of the coupler ring 4, so that the hub unit may be further increased in the torsion strength. That is, the embodiment provides the hub unit H2 which is adapted for the effective prevention of the caulking cracks or the crack formation during use, and which is increased in the torsion strength.

According to the first and second embodiments, it is preferred that a plurality of recesses are formed in a side surface of the second end of the coupler ring 4 at predetermined circumferential space intervals (constant space intervals, for example) and the bent portion 23 is wedged into these recesses. The hub unit with the recesses so formed may be increased in the torsion strength even further because the bent portion 23 of the hub shaft 2 is wedged into these recesses so as to be more firmly fixed to the coupler ring. Incidentally, the recess may have any suitable configuration.

It is noted that the hub unit of the invention is not limited to the foregoing embodiments and may naturally be subjected to design variations as needed. While the above description illustrates the case where the hub unit is applied to the freewheel hub mechanism of the part-time 4WD vehicle, the application of the invention is not limited to this. The invention may be applied to various types of hub units fixed to place by way of the shaft-end caulking.

The aforementioned constitution of the invention is adapted for the effective prevention of the caulking cracks during the shaft-end caulking process or the crack formation during use because the whole body of the second-end chamfer portion 44, formed at the circumferential edges of the second axial ends of the spline ridges 41b of the inner-peripheral spline portion 41 of the coupler ring 4, is located axially outwardly of the spline portion 24 of the hub shaft 2.

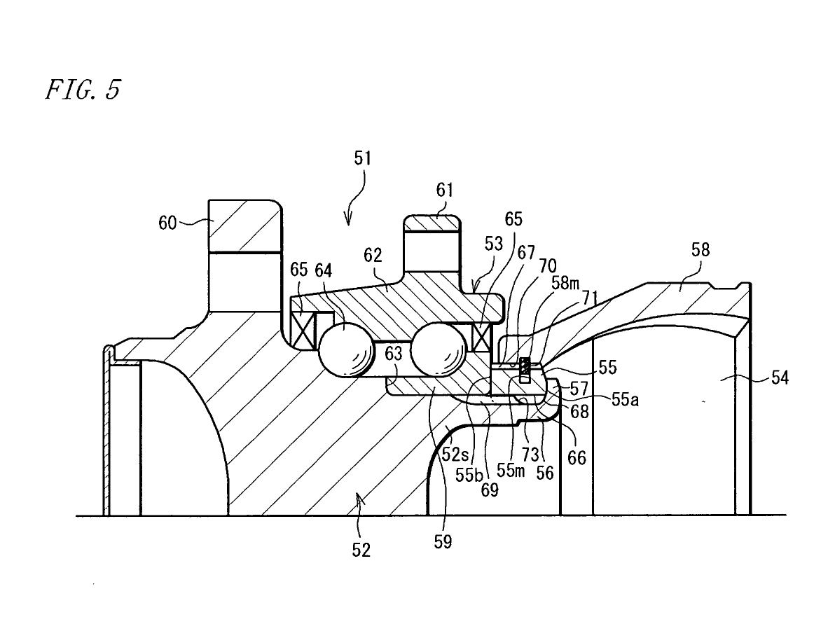

Next, description is made on a rolling bearing assembly according to the invention. The following description is made by way of example of a case where the invention is applied to a vehicular hub unit incorporated in a vehicle such as an automotive vehicle. In the following description, a road-wheel side (the left-hand side as seen in FIG. 5) will be referred to as an outer side, whereas an axle side (the right-hand side as seen in FIG. 5) will be referred to as an inner side. FIG. 5 shows a rolling bearing assembly 51 according to the invention. The rolling bearing assembly 51 includes: a hub shaft 52 (also called a hub wheel); a rolling bearing 53 mounted on the hub shaft 52; a constant-velocity joint 54 connected to an inner end of the hub shaft 52; and an annular member 55 for interconnecting the hub shaft 52 and the constant-velocity joint 54.

This rolling bearing assembly 51 is assembled as follows. The rolling bearing 53 is mounted on an outside surface of the hub shaft 52. The annular member 55 is moved from the inner side toward the outer side for spline-engagement with the rolling bearing and then, is pressed against the rolling bearing 53. Subsequently, the annular member 55 is caulk-fixed to place by means of a caulking portion 57. As shown in FIG. 5, the hub shaft 52 is formed with the caulking portion 57 at an axial end thereof. The caulking portion 57 is formed by radially outwardly bending a caulking cylinder portion 56 by press working or the like, the caulking cylinder portion 56 disposed at the axial end of the hub shaft 52. The annular member 55 has an inner-side end 55a thereof pressed by the caulking portion 57 whereby the annular member 55 is assuredly fixed to place. Thus, an outer-side end 55b of the annular member 55 is pressed against the rolling bearing 53, whereby a desired pre-load is axially applied to the rolling bearing 53 so that the rolling bearing is prevented from disengaging from the hub shaft 52.

The constant-velocity joint 54 includes: a housing 58 coupled to the annular member 55; and a driving shaft, an inner ring for the constant-velocity joint, a cage, a plurality of balls and the like (not shown) which are disposed within the housing 58. The constant-velocity joint transmits a power from the driving shaft to the hub shaft 52. The hub shaft 52 is formed with a small-diameter portion 52s extending from an intermediate place thereof to the inner end thereof. Mounted on this small-diameter portion 52s are an inner ring 59 (to be described hereinlater) of the rolling bearing 53 and the annular member 55. The hub shaft 52 is formed with a flange 60 at an outer end thereof. The road wheel and the like are mounted to the flange 60 by way of bolts.

The above rolling bearing 53 is constituted as a double-row angular contact ball bearing, which includes: a single outer ring 62 formed with a pair of outer raceways and possessing amounting flange 61 formed on its outside surface and used for mounting the bearing assembly to a suspension and the like; and the inner ring 59 formed with an inner raceway opposing the outer raceway and fitted on the small-diameter portion 52s on its inside surface. The inner ring 59 is fixed to place as clamped between the outer-side end 55b of the annular member 55 and a step surface 63 formed at the small-diameter portion 52s. The double-row ball bearing 53 further includes: balls 64 as rolling elements rollably arranged between the inner and outer raceways in the opposing relation; and a cage member for circumferentially retaining the individual balls with predetermined spacing.

The above rolling bearing assembly 51 may be assembled to an automotive vehicle as follows. The outer ring 62 is carried by the suspension system via the mounting flange 61, and a drive wheel is fixed to the hub shaft 52 by way of the flange 60 of the hub shaft 52. Then, an outer end of the unillustrated driving shaft is engaged with an inside portion of the inner ring for constant-velocity joint disposed in the housing 58. While the automotive vehicle is traveling, the rotation of the inner ring for constant-velocity joint is transmitted to the drive wheel fixed to the hub shaft 52 by way of the plural balls and the housing 58.

The annular member 55 is caulk-fixed to the inner end of the hub shaft 52 and is coupled to the housing 58 of the constant-velocity joint 54, thereby interconnecting the hub shaft 52 and the constant-velocity joint 54. The annular member 55 includes a first female spline 66 (inner-peripheral spline) formed on an inside surface thereof, and a first male spline 67 formed on an outside surface thereof. The annular member further includes a curved inside corner portion 68 at the inner-side end thereof, to which portion the caulking portion is caulked. This inside corner portion 68 has an axial section defined by a gentle curve, such that the caulking portion 57 may not sustain cracks when an outside surface of the caulking cylinder portion 56 is deformed along this inside corner portion 68. The hub shaft 52 is formed with a second male spline 69 (outer-peripheral spline) on its outside surface at place near the inner end thereof. The first female spline 66 of the annular member 55 is spline-engaged with the second male spline 69 whereby the annular member 55 is fixed to the inner end of the hub shaft 52 in a clearance-free fashion.

On the other hand, the first male spline 67 of the annular member 55 is spline-engaged with a third female spline 70 formed on an inside surface of an outer end of the housing 58. A snap ring 71 is looped about the annular member as interposed between the first male spline 67 and the third female spline 70 in spline engagement, thereby preventing the housing 58 and the annular member 55 from disengaging from each other. The snap ring 71 is shaped like a partially cut away ring. The snap ring 71 is settled in a first lock groove 55m formed all around the outside surface of the annular member 55 and in a second lock groove 58m formed all around the inside surface of the outer end of the housing 58, thereby preventing the housing 58 and the annular member 55 from axially displacing from each other.

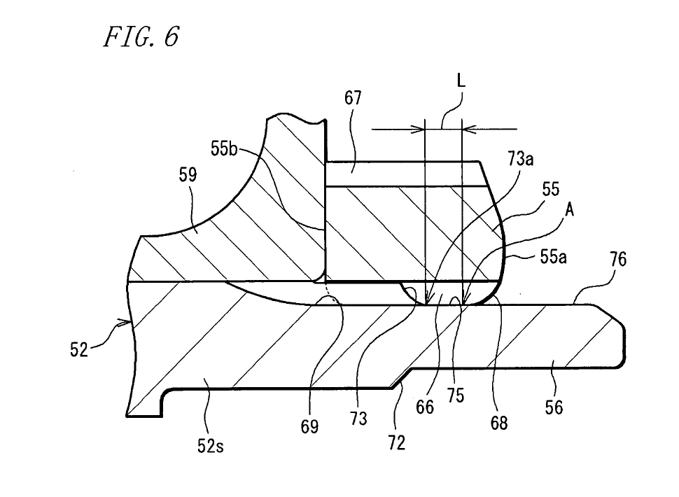

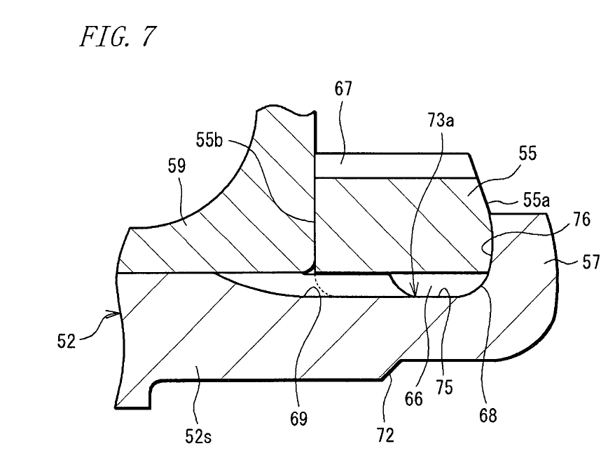

As shown in FIG. 6, the caulking cylinder portion 56 formed at the hub shaft 52 is shaped like a cylinder which is extended to the inner side for a required length from a step portion 72 and has a smaller thickness than the other parts of the hub shaft. The caulking cylinder portion 56 in the state shown in FIG. 6 is radially outwardly bent by press working or the like, so as to be caulked to the annular member 55. The second male spline 69 of the hub shaft 52, in spline-engagement with the annular member 55, is axially extended toward the outer side from a proximal end of the caulking cylinder portion 56. The second male spline includes an upwardly cut-away portion 73 at an axial inner end thereof.

An axially inner-side end 73a of the second male spline 69 (the upwardly cut-away portion 73) is shifted from an inner-side end of the hub shaft 52 toward the outer side far enough to ensure that the second male spline 69 is not susceptible to the plastic deformation of the caulking portion 57 so caulked. As seen in FIG. 6, the axial end 73a of the second male spline 69 (the upwardly cut-away portion 73) is located on the outer side from a contact point A (an inner end of a top of a ridge of the first female spline 67 of the annular member 55) at which the inside corner portion 68 is in contact with the outside surface of the caulking cylinder portion 56. Hence, an axial linear portion 75 exists between the above contact point A and the axial end 73a. By virtue of the existence of the linear portion, the plastic deformation of the caulking portion 57 so caulked does not reach the second spline 69. That is, the above phrase “far enough to ensure that the second male spline 69 is not susceptible to the plastic deformation of the caulking portion” means the existence of the above linear portion. The linear portion may preferably have a length L of 0 to 2.0 mm, or more preferably of 0.05 to 2.0 mm.

A measure for permitting the annular member 55 to be mounted in the aforementioned manner may be, but not limited to, to vary the width (distance between the inner-side end 55a and the outer-side end 55b) of the annular member 55, to change an axial position of the annular member 55 relative to the second male spline 69, to change a position of the axial-innermost end 73a of the upwardly cut-away portion 73 or the like, for example.

Since the axial end 73a of the second male spline 69 is located on the outer side from the above contact point A, the caulking portion 57 may be formed without causing the plastic deformation of the second male spline 69 (the upwardly cut-away portion 73). Thus, only a portion 76 free of the second spline 69 is deformed to form the caulking portion 57, so that the caulking portion 57 does not undergo rapid deformation (local deformation) and is prevented from encountering the crack formation.

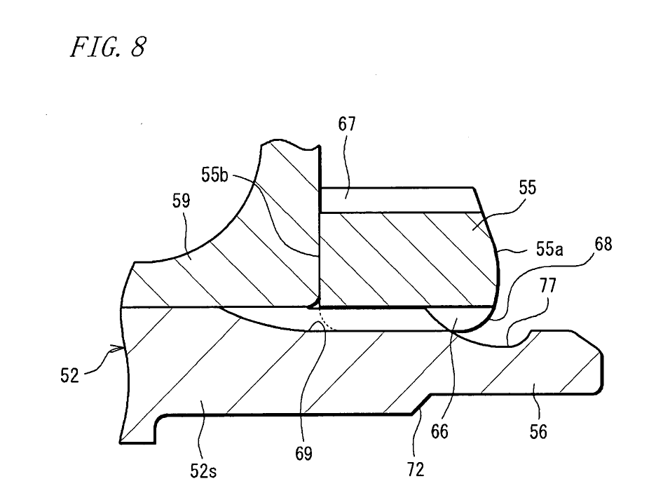

FIG. 8 is a diagram explaining a prior-to-caulking state of the rolling bearing assembly according to the second embodiment. This embodiment differs from the first embodiment in that the outside surface of the caulking cylinder portion 56 is formed with a dent portion 77 in conformity with the inside corner portion 68 of the annular member 55, to which inside corner portion the caulking cylinder portion is caulked. The other parts are constituted the same way as in the first embodiment and hence, are represented by the same reference characters, the description of which is dispensed with. As shown in FIG. 8, the dent portion 77 is so formed as to range from the outside surface of the caulking cylinder portion 56 to the second male spline 69.

The dent portion 77 is formed in an annular shape along the outside circumference of the caulking cylinder portion 56. Prior to the caulking, the dent portion 77 is shaped like an arc in section defined by a line extending from a start point on the outer side as gently curved radially inwardly and sharply curved in a range between an apex to an end point. After the caulking, the dent portion 77 is so shaped as to conform to a peripheral surface of the inside corner portion 68 of the annular member 55. The dent portion 77 of the caulking cylinder portion 56 is formed to conform to the inside corner portion 68 in this manner, thus facilitating the deformation of the caulking cylinder portion 56. Hence, the effect to prevent the crack formation at the caulking portion 57 may be enhanced. The configuration of the dent portion 77 is not limited to that of the embodiment. The dent portion may have any other configuration.

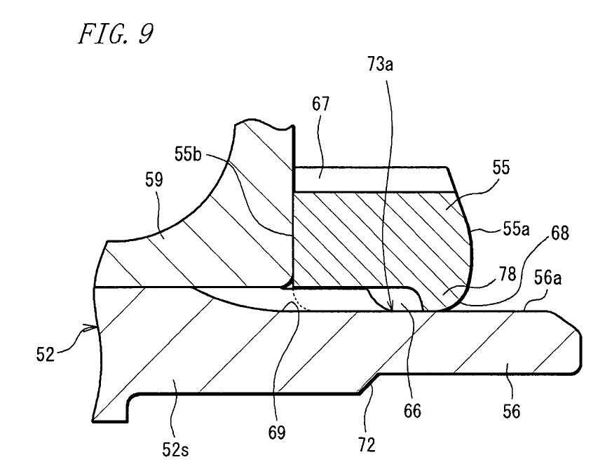

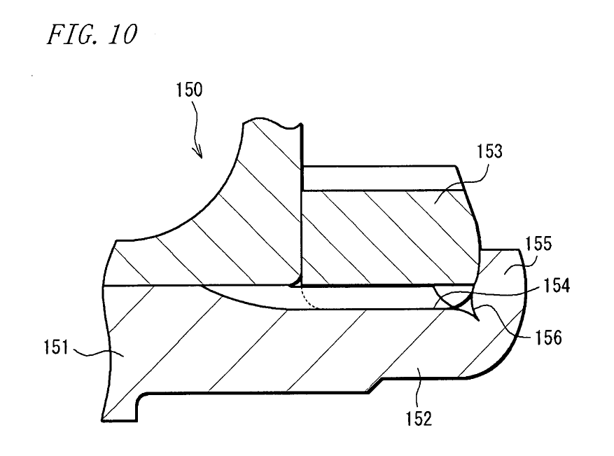

FIG. 9 is a diagram explaining a prior-to-caulking state of a rolling bearing assembly according to a third embodiment of the invention. This embodiment differs from the first embodiment in that the first female spline 66 (inner-peripheral spline) of the annular member 55 is formed only in a range between the outer-side end thereof and an axial intermediate point thereof. The other parts of the bearing assembly are constituted the same way as in the first embodiment and hence, are represented by the same reference characters, the description of which is dispensed with. As shown in FIG. 9, the first female spline 66 of the annular member 55 is so formed as to extend from the outer-side end to some intermediate point beyond the center of the annular member. Namely, the first female spline 66 is not extended through the inner-side end or the outer-side end of the annular member 55.

Accordingly, the inside corner portion 68 defines a ring portion 78 which is free from a circumferential corrugation defined by the first female spline 66, so as to be uninterruptedly extended in the circumferential direction. Because of the existence of the ring portion 78, the axial end 73a of the second male spline 69 is shifted toward the outer side from the ring portion 78.

Therefore, the caulking portion 57 is deformed with its opposing surface to the ring portion 78 of the annular member 55 evenly pressed there against, so that the effect to prevent the crack formation at the caulking portion may be enhanced even further. It is noted that the invention is not limited to the foregoing embodiments and the constitutions of the annular member, the rolling bearing, the hub shaft and the like may be modified.

According to the invention as described above, the local deformation of the caulking portion 57 is obviated so that the crack formation at the caulking portion is prevented. Hence, the invention may provide the rolling bearing assembly 51 featuring high reliability.

Next, description is made on an apparatus for assembling the rolling bearing assembly for use in the hub unit shown in FIG. 1 and the like, and for assembling the rolling bearing assembly shown in FIG. 5 and the like.

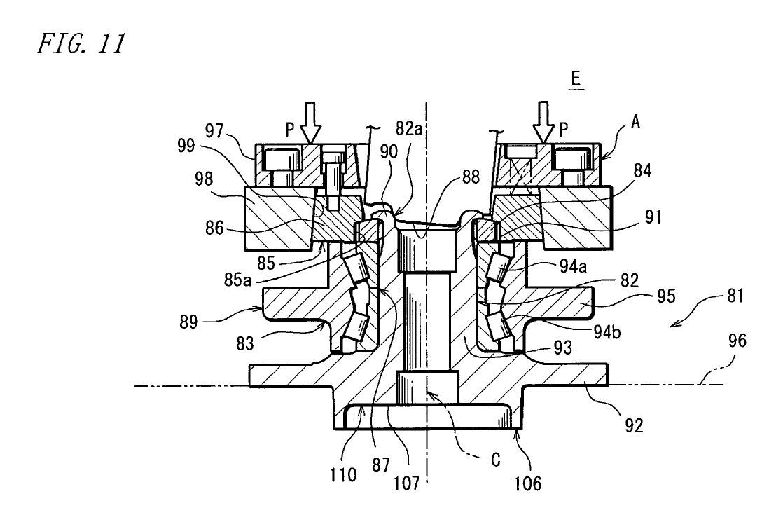

FIG. 11 is a sectional side view showing an essential part of an assembling apparatus according to an embodiment of the invention. The figure shows a state where a rolling bearing assembly (hereinafter, also referred to as the bearing assembly or the hub unit) is set in the assembling apparatus and assembled as subjected to a caulking process.

First, a constitution of the bearing assembly is described with reference to FIG. 11. A rolling bearing assembly 81 for axle shaft includes a hub shaft (inner shaft) 82 and a double-row tapered roller bearing 83. A caulking portion 90 is defined by a first end of the hub shaft 82.

The hub shaft 82 includes a cylindrical shaft portion 93, and a flange 92 formed on an outside surface of a second end of the shaft portion 93 and mounted with unillustrated road wheel and brake rotor. A projecting boss portion 106 is formed centrally of a mounting surface of the flange 92, to which surface the road wheel and the like are mounted. An end surface of the boss portion 106 defines a recess 110 with center at an axis C of the hub shaft 82. A bottom 107 of the recess 110 defines a flat plane orthogonal to the axis C of the hub shaft 82.

The double-row tapered roller bearing 83 is mounted on the shaft portion 93 of the hub shaft 82. Furthermore, a splined annular member 84 (coupler ring) is mounted on the hub shaft 82 at the first end thereof or at place shifted from the double-row tapered roller bearing 83 toward a tip of the shaft portion 93. A part of the first end of the shaft portion 93 is radially outwardly expanded to form the caulking portion 90.

While a state before the caulking portion 90 is radially outwardly expanded by a caulking tool 88 is not shown, the caulking portion 90 prior to the caulking has a shape of a short cylinder projecting from an end face of the first end of the shaft portion 93. The shaft portion 93 having the annular member 84 mounted thereon is formed with a spline on a corresponding portion of an outside surface thereof, so that the annular member 84 is spline-engaged with the shaft portion 93.

The double-row tapered roller bearing 83 includes: an inner ring member 87 fitted on the shaft portion 93 and possessing two inner raceways; an outer ring member 89 possessing two outer raceways; and two rows of rolling elements 94a, 94b. The outer ring member 89 is formed with a flange 95 on an outside surface thereof, the flange extended radially outwardly. The bearing assembly 81 is fixed to an unillustrated axle shaft case of a vehicle body via the flange 95.

A method of assembling the bearing assembly using the assembling apparatus of the invention is carried out as follows. First, the inner ring member 87 of the roller bearing assembly 83 is fitted on the shaft portion 93 of the hub shaft 82. Subsequently, the annular member 84 is fitted on the outside surface of the end of the shaft portion 93 of the hub shaft 82. An outer periphery of an end 82a of the hub shaft 82 is radially outwardly caulked with the caulking tool 88, so as to fix the inner ring member 87 and the annular member 84 to the hub shaft 82 in an anti-fall fashion. The annular member 84 is fitted on the shaft portion 93 of the hub shaft 82 in an adjoining and side-to-side contact relation with the inner ring member 87 of the roller bearing 83 fitted on an axially central part of the shaft portion 93.

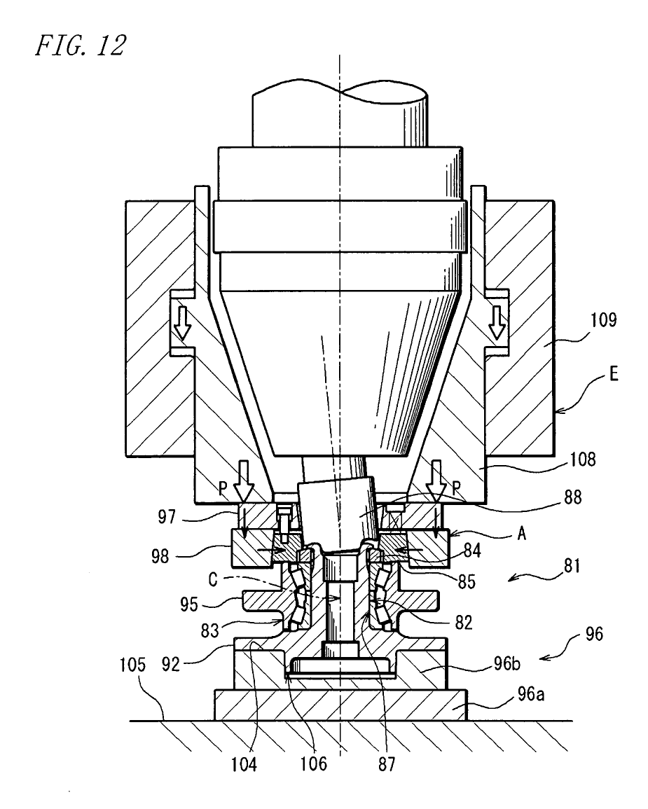

The caulking process is performed as follows. As shown in FIG. 12, the hub shaft 82 with the inner ring member 87 of the roller bearing 83 and the annular member 84 fitted thereon is placed on a horizontal base 96. The caulking tool 88 disposed upwardly of the hub shaft 82, a diametral-expansion inhibiting jig A to be fitted about the caulking tool 88 and the first end of the hub shaft 82, and a pressingly driving machine E for driving the diametral-expansion inhibiting jig A are operated for caulking.

The caulking process is performed by swing caulking known in the art. Specifically, the hub shaft 82 with the inner ring member 87 of the roller bearing 83 and the annular member 84 fitted thereon is set on the horizontal base 96 as vertically directing the axis C of the hub shaft 82. The caulking tool 88 above the hub shaft 82 is moved to the hub shaft 82. The caulking tool 88 rotating about the axis C of the hub shaft 82 as inclined at a predetermined angle relative to the axis C is pressed against the first end of the hub shaft 82. The caulking tool 88 presses down on the short cylinder portion at the first end of the hub shaft 82 thereby forming the caulking portion 90 plastically deformed in the radially outward direction. The plastically deformed caulking portion 90 presses down on an outer side of the annular member 84.

A horizontal base plate 96a is disposed on a flat block 105, and a cradle 96b is disposed on the base plate 96a. The hub shaft 82 is set on the horizontal base 96 as follows. As shown in FIG. 12, the cradle 96b is centrally formed with a recess so that a top side of the cradle 96b defines a ring-like horizontal rest surface 104. The boss portion 106 at a lower end of the hub shaft 82 is inserted in the recess. The flange 92 of the hub shaft 82 is seated on the horizontal rest surface 104 so as to fix the hub shaft 82. Thus, the hub shaft may be set stably and may also have its axis C aligned with the vertical direction with high accuracy.

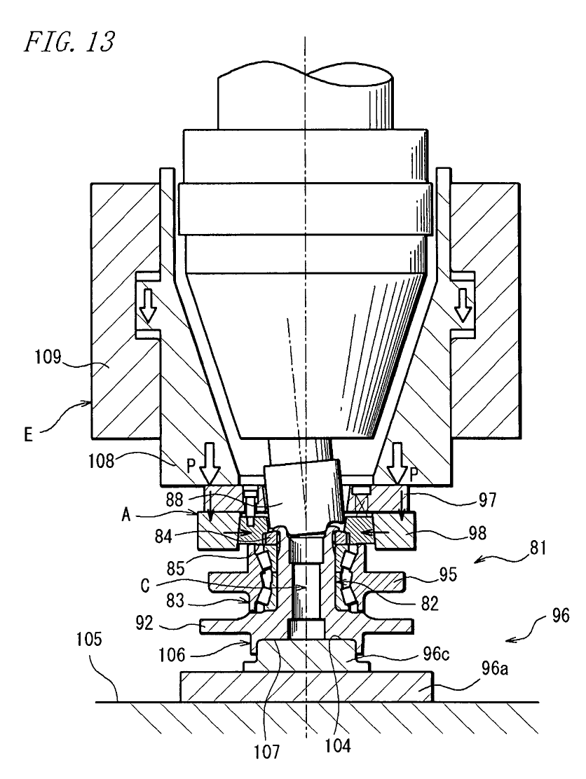

Alternatively, as shown in FIG. 13, the horizontal base plate 96a may be set on the flat block 105, and a cradle 96c having a convex shape in vertical section and defining a horizontal circular rest surface 104 at its top may be set on the base plate 96a. When the hub shaft 82 is installed on the base 96, the aforesaid recessed bottom 107 of the hub shaft 82 is set on the horizontal rest surface 104 so as to fix the hub shaft 82. Thus, the hub shaft 82 may be set stably and may also have its axis C aligned with the vertical direction with high accuracy.

When the assembling apparatus according to each of the embodiments shown in FIG. 12 and FIG. 13 performs the caulking process, the apparatus brings a constraining ring 85 of the diametral-expansion inhibiting jig A into fitting contact against an outside surface of the annular member 84 so as to prevent the diametral expansion of the annular member 84 caused by the caulking process.

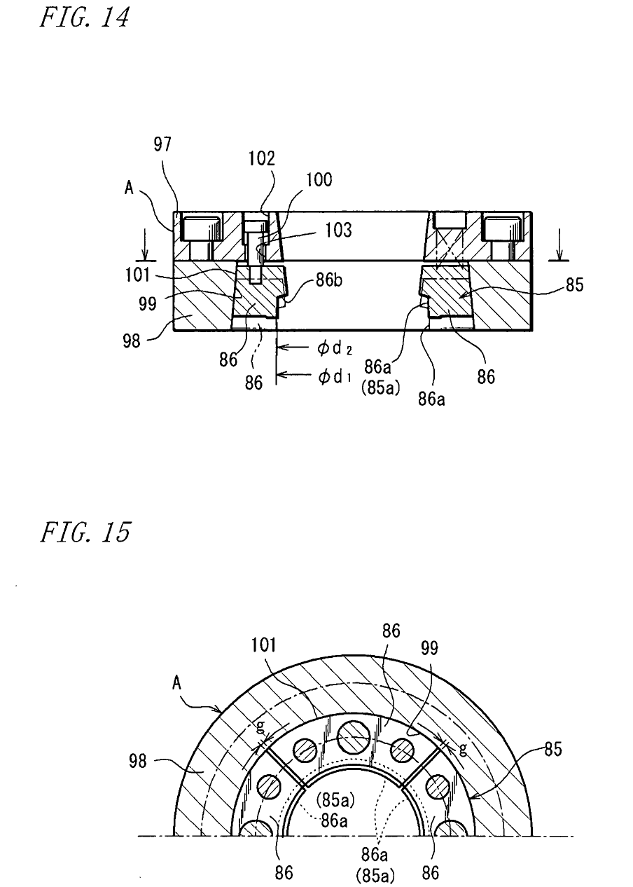

The diametral-expansion inhibiting jig A is a ring-like block body allowing the tiltingly rotated shaft-like caulking tool 88 to be inserted therein via a gap therebetween. As illustrated by a vertical sectional view of FIG. 14 and a sectioned plan view of FIG. 15, the diametral-expansion inhibiting jig A includes: a ring-like base 97 having horizontal top and bottom sides; a ring-like guide block 98 secured to an outer peripheral side of the bottom of the ring-like base 97; and the constraining ring 85 suspendingly retained on the ring-like base 97 and disposed inwardly of the ring-like guide block 98.

As shown in FIG. 12 or FIG. 13, disposed above the diametral-expansion inhibiting jig A is the pressingly driving machine E, which includes: a ring-like pressing member 108 disposed outside of the caulking tool 88; and a fixed drive block 109 fitted about the pressing member 108 for moving up or down the pressing member 108 and applying a downward pressing force to the pressing member 108. The pressing member 108 is mounted on the top side of the ring-like base 97 of the diametral-expansion inhibiting jig A, while the pressingly driving machine E operates to move up or down the ring-like base 97 and to drive the ring-like base 97 to apply the downward pressing force as indicated by an arrow P.

Accordingly, as the pressingly driving machine E operates to move down the ring-like base 97, the guide block 98 and the constraining ring 85 are moved down. When the constraining ring 85 is abutted against the annular member 84 fitted about the hub shaft 82 of the bearing assembly 81, the pressingly driving machine E operates to apply the downward pressing force to the ring-like base 97, as indicated by the arrow P. This pressing force acts on the constraining ring 85 via the guide block 98, causing the constraining ring 85 to press the annular member 84 vertically downwardly and to clench the annular member 84 radially inwardly (as will be described hereinlater). The pressingly driving machine E may use hydraulic pressure as a driving source, for example.

As shown in FIG. 14 and FIG. 15, the guide block 98 of the diametral-expansion inhibiting jig A is fixed to the ring-like base 97 by means of a bolt member. An inside surface of the guide block 98 defines a tapered inner periphery 99 increased in diameter toward bottom. The constraining ring 85 of the diametral-expansion inhibiting jig A is constituted by a plurality of separate constraining ring segments 86 arranged in a circumferential direction, as shown in FIG. 15. While FIG. 15 illustrates the constraining ring divided into four segments, the number of the constraining ring segments is optional.

Referring to FIG. 14 and FIG. 15, and outside arcuate surface 101 of the constraining ring segment 86 defines a slanted surface having the same taper angle (inclination) as that of the tapered inner periphery 99 of the guide block 98, so that the constraining ring segment 86 is adapted for sliding movement along the tapered inner periphery 99 of the guide block 98.

An inside surface of the constraining ring segment 86 defines an arcuate surface and includes: an inside abutment surface 86a abutted against the outside surface of the annular member 84 for preventing a radially outward deformation of the annular member 84; and a downside arcuate face 86b abutted against an outer-circumferential edge of an axial upper end of the annular member 84 for pressing the annular member 84 toward the inner ring member 87. Thus, the inside surface of the constraining ring segment 86 defines a stepped arcuate surface.

A radial segmentation surface of each constraining ring segment 86 defines a vertical plane. The constraining ring segments are arranged in a single ring form as defining a gap g between a respective pair of corresponding segmentation surfaces thereof, and are retained by the ring-like base 97 as providing an upper and a lower gap and in a face-to-face relation. Furthermore, the constraining ring segments 86 are free to move toward or away from the ring-like base 97, and are not constrained from moving radially relative to the ring-like base 97. That is, the constraining ring segments 86 are retained as allowed to move radially for a small distance. Specifically, the constraining ring segment 86 is coupled to a distal end of a bolt member 100 inserted through a counterbore 102 and a small through-hole 103 with minor gaps, the counterbore 102 and small through-hole 103 formed in the ring-like base 97. The individual constraining ring segments 86 are independent from one another, so as not to be affected by the movement of the other constraining ring segments 86. As abutted against the annular member 84 of the bearing assembly 81, therefore, the individual constraining ring segments 86 are enabled to move toward the ring-like base 97 and move radially inwardly as guided by the guide block 98.

The operation of the diametral-expansion inhibiting jig A is described in further details. As shown in FIG. 11, the aforesaid pressingly driving machine E operates to move down the diametral-expansion inhibiting jig A to the bearing assembly 81 set on the base 96. The inside abutment surfaces 86a (85a) or the downside arcuate faces 86b of the constraining ring segments 86 (the constraining ring 85) are brought into contact against the outside surface or the top side of the annular member 84 fitted about the hub shaft 82. When the diametral-expansion inhibiting jig A is further lowered and the pressingly driving machine E applies the vertically downward pressing force, the individual constraining ring segments 86 are moved in a direction to decrease the diameter (radially inwardly toward the axis C) by way of the tapered inner periphery 99 of the guide block 98. Thus, the tapered inner periphery 99 of the guide block 98 applies a radially inward force and a downward force to the constraining ring segments 86, whereby the inside abutment surfaces 86a of the constraining ring segments 86 are pressed against the outside surface of the annular member 84 for clenching the annular member 84 from the outer peripheral side. Furthermore, the downside arcuate faces 86b of the constraining ring segments 86 vertically downwardly press the annular member 84 for further stabilizing the position of the annular member 84.

The constraining ring segments 86 are retained by the bolt member 100 in a manner to be free to move toward or away from the ring-like base 97 and to be unconstrained from moving radially relative to the ring-like base 97. Thus, the constraining ring segments 86 are allowed to move radially (free to increase or decrease the diameter) without varying the angle of the inside abutment surfaces 86a thereof relative to the axis C of the hub shaft 82. That is, as shown in FIG. 14, the constraining ring segments 86 are adapted for parallel movement along the tapered inner periphery 99 of the guide block 98 as maintaining their as-is position. By moving the constraining ring segments 86 in parallel, the inside abutment surfaces 86a of the constraining ring segments 86 are adapted to vary an inside diameter from Φd₁ to Φd₂ without varying their angles. Therefore, the constraining ring segments 86 are able to keep their inside abutment surfaces 86a in face-to-face contact with the outside surface of the annular member 84 during a time period between contact making with the annular member 84 and pressure application onto the annular member.

An inside abutment surface 85a (inside abutment surfaces 86a) of the constraining ring 85 (constraining ring segments 86) abutted against the outside surface of the annular member 84 may preferably be a smooth surface, although a spline 91 is formed on the outside surface of the annular member 84. In addition, the inside abutment surfaces 86a of the constraining ring segments 86 are abutted against the outside surface of the annular member 84 of the bearing assembly 81 over the entire axial length thereof, so that the annular member 84 is prevented from being tilted by a clenching force of the constraining ring segments 86.

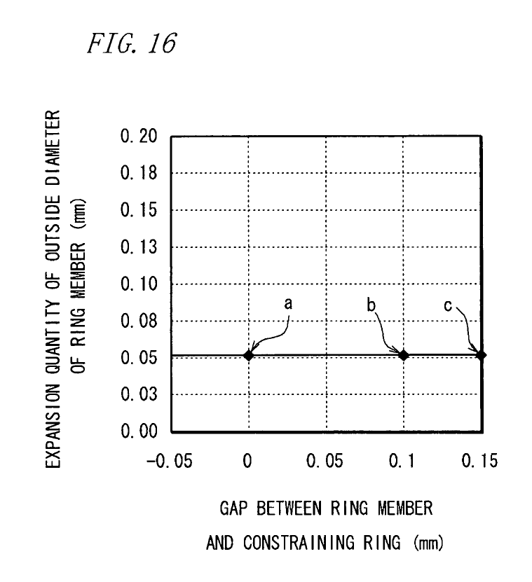

Referring to FIG. 16, description is made on the results of measurement taken on the expansion quantity of the outside diameter of the annular member 84 when the end 82a of the hub shaft 82 was caulked while the annular member 84 was clenched on the outside surface thereof by means of the aforementioned diametral-expansion inhibiting jig A. One constraining ring 85 was used for caulk-assembling each of the annular members (coupler rings) 84 formed in three kinds of finished dimensions. These three annular members 84 had dimensional errors within specified tolerances. The inside diameter of the constraining ring 85 to be described as below was determined in a state where the constraining ring segments were arranged in the ring form as providing the predetermined gaps g, as shown in FIG. 15.

FIG. 16 is a plot wherein the abscissa is the gap dimension between the annular member 84 and the constraining ring 85 and the ordinate is the expansion quantity of the outside diameter of the annular member after the caulking. As shown in FIG. 16, the expansion quantity of the outside diameter of the annular member 84 is on the order of 0.055 mm in each of the cases where the outside diameter of the annular member 84 is equal to the inside diameter of the constraining ring 85 (inside abutment surface 85a) (a value on the abscissa is 0 mm: arrow a), where the outside diameter of the annular member 84 is 0.1 mm smaller (a value on the abscissa is 0.1 mm: arrow b), and where the outside diameter of the annular member 84 is 0.15 mm smaller (a value on the abscissa is 0.15 mm: arrow c). This indicates that the apparatus of the invention is capable of restricting the expansion quantity of the annular member 84 to a constant value, despite the variations of the outside diameter of the annular member 84.

According to the above assembling apparatus, the constraining ring 85 of the diametral-expansion inhibiting jig A is adapted to vary the inside diameter thereof according to the outside diameter of the annular member 84 of the bearing assembly 81. In addition, the constant pressing force from the pressingly driving machine E is used for applying the constant clenching force to the annular member 84. Therefore, the expansion quantity of the annular member 84 may be restricted to the constant value even if the outside diameter of the annular member 84 is varied within the dimensional tolerances or if the inside abutment surface 85a of the constraining ring 85 is worn due to long-term service and a minor dimensional variation results.

According to the invention providing the assembling apparatus for bearing assembly and assembly method thereof, the expansion of the annular member 84 assembled by the caulking process may be limited so that the bearing assembly may be assembled with high accuracies. Furthermore, the annular member 84 may be prevented from sustaining the deformation or cracks caused by an excessive expansion. In addition, the expansion of the annular member 84 caused by the caulking process is unaffected by the finished outside diameter of the annular member 84, so as to be restricted to the constant quantity. That is, the expansion of the annular member 84 may be restricted to the constant quantity despite the variations of the outside diameter of the annular member 84. This makes it possible to increase the dimensional accuracies and to correct the deformation of the annular member 84. Accordingly, the bearing assemblies 81 featuring good and consistent quality may be provided. What is more, the assembling operation may be carried on without exchanging the constraining rings 85 if the annular members 84 are varied in the outside diameter. Hence, the invention achieves an increased productivity and may be favorably applied to the mass production of the bearing assemblies 81.

1. A hub unit comprising:
a hub shaft including: a sleeve formed about an outside surface of a rotary shaft in a coaxial relation therewith; a flange formed at a first axial end of the sleeve and extended radially outwardly therefrom; and a bent portion formed at a second axial end of the sleeve as bent radially outwardly; and a spline portion formed on an outside surface of the sleeve at place in the vicinity of the bent portion;
a rolling bearing including an inner ring, an outer ring and rolling elements interposed between the inner ring and the outer ring, and fitted on the sleeve of the hub shaft; and
a coupler ring including an inner-peripheral spline portion formed on an inside surface thereof and an outer-peripheral spline portion formed on an outside surface thereof, and meshed with the spline portion of the hub shaft at the inner-peripheral spline portion,
the bent portion of the hub shaft pressing the rolling bearing via the coupler ring,
wherein a second-end chamfer portion is formed by curvedly chamfering circumferential edges of second axial ends of spline ridges of the inner-peripheral spline portion of the coupler ring and the whole body of the second-end chamfer portion is located axially outwardly of the spline portion of the hub shaft.

2. A hub unit according to claim 1, wherein a first-end chamfer portion is formed by curvedly chamfering circumferential edges of first axial ends of the spline ridges of the inner-peripheral spline portion of the coupler ring and the whole body of the first-end chamfer portion is located in spline grooves of the spline portion of the hub shaft.

3. A hub unit according to claim 1, wherein a plurality of recesses are formed in a side surface of a second axial end of the coupler ring and the bent portion is wedged into these recesses.

4. A rolling bearing assembly comprising: a hub shaft having a radially outwardly caulked caulking portion at an inner-side end thereof; a rolling bearing mounted on an outside surface of the hub shaft; and an annular member spline-engaged with the outside surface of the hub shaft and caulk-fixed to place by the caulking portion,
wherein an inner-side axial end of an outer-peripheral spline formed on the hub shaft is shifted from the inner-side end of the hub shaft to an outer side far enough to ensure that the outer-peripheral spline is not susceptible to the plastic deformation of the caulking portion thus caulked.

5. A rolling bearing assembly according to claim 4, wherein the caulking portion is formed by bendably deforming a caulking cylinder portion formed with a dent portion on an outside surface thereof, the dent portion conforming to an inside corner portion of the annular member.

6. A rolling bearing assembly according to claim 4, wherein an inner-peripheral spline formed on the annular member is extended only in a range between an outer-side end of the annular member and an axial intermediate point thereof.

7. A method of manufacturing a rolling bearing assembly comprising the steps of mounting a rolling bearing on an outside surface of a hub shaft including a caulking cylinder portion at an inner-side end thereof; bringing an annular member into spline-engagement with an outer-peripheral spline formed on the hub shaft by sliding the annular member from an inner side toward an outer side; and caulk-fixing the annular member to place with a caulking portion formed by radially outwardly bending the caulking cylinder portion,
wherein the annular member is spline-engaged with the outer-peripheral spline, an axial end of which is shifted toward the outer side far enough to ensure that the outer-peripheral spline is not susceptible to the plastic deformation of the caulking portion.

8. An assembling apparatus for rolling bearing assembly which is assembled by fitting an annular member on an outside surface of an end of an inner shaft having an inner ring member fitted thereon, and radially outwardly caulking an outer-peripheral end of the inner shaft thereby fixing the annular member and the inner ring member to the inner shaft in an anti-fall fashion,
the apparatus comprising a constraining ring which is brought into fitting contact against an outside surface of the annular member during the caulking process, thereby preventing the diametral expansion of the annular member.

9. An assembling apparatus for rolling bearing assembly according to claim 8, wherein the constraining ring comprises a plurality of separate constraining ring segments arranged in a circumferential direction.

10. An assembling apparatus for rolling bearing assembly according to claim 9, wherein the constraining ring segment is allowed to move radially without varying the angle of an inside abutment surface thereof relative to an axis of the inner shaft.

11. An assembling apparatus for rolling bearing assembly according to claim 8, wherein a spline is formed on the outside surface of the annular member whereas an inside abutment surface of the constraining ring brought into contact against the outside surface of the annular member is defined by a smooth surface.

12. A method of assembling a bearing assembly comprising the steps of fitting an annular member on an outside surface of an end of an inner shaft having an inner ring member fitted thereon, and radially outwardly caulking an outer-peripheral end of the inner shaft thereby fixing the annular member and the inner ring member to the inner shaft in an anti-fall fashion,
wherein a constraining ring is brought into fitting contact against an outside surface of the annular member during the caulking process, thereby preventing the diametral expansion of the annular member.

13. A method of assembling a bearing assembly according to claim 12, wherein the constraining ring comprises a plurality of separate constraining ring segments arranged in a circumferential direction and the individual constraining ring segments are moved in a diameter decreasing direction for making contact against the outside surface of the annular member.

14. A hub unit according to claim 2, wherein a plurality of recesses are formed in a side surface of a second axial end of the coupler ring and the bent portion is wedged into these recesses.

15. A rolling bearing assembly according to claim 5, wherein an inner-peripheral spline formed on the annular member is extended only in a range between an outer-side end of the annular member and an axial intermediate point thereof.

16. An assembling apparatus for rolling bearing assembly according to claim 9, wherein a spline is formed on the outside surface of the annular member whereas an inside abutment surface of the constraining ring brought into contact against the outside surface of the annular member is defined by a smooth surface.

17. An assembling apparatus for rolling bearing assembly according to claim 10, wherein a spline is formed on the outside surface of the annular member whereas an inside abutment surface of the constraining ring brought into contact against the outside surface of the annular member is defined by a smooth surface.
